(19) United States
(12) Patent Application Publication
(10) Pub. No.: US 2019/0073205 A1
(43) Pub. Date: Mar. 7, 2019

(54) SOFTWARE MANAGEMENT DEVICE, SOFTWARE MANAGEMENT SYSTEM, AND NON-TRANSITORY COMPUTER READABLE MEDIUM STORING PROGRAM

(71) Applicant: FUJI XEROX CO., LTD., Tokyo (JP)

(72) Inventors: Haruki MATSUI, Kanagawa (JP); Koji HASHIMOTO, Kanagawa (JP); Toru NAKATANI, Kanagawa (JP); Takeshi OGURA, Kanagawa (JP); Aiko NOZUE, Kanagawa (JP)

(73) Assignee: FUJI XEROX CO., LTD., Tokyo (JP)

(21) Appl. No.: 16/115,587

(22) Filed: Aug. 29, 2018

(30) Foreign Application Priority Data
Sep. 5, 2017 (JP) 2017-170343

(51) Int. Cl. G06F 8/61; G06F 8/65; H04L 29/08

(52) U.S. Cl. CPC G06F 8/61; G06F 3/123; H04L 67/34; G06F 8/65

(57) ABSTRACT

A software management device includes a determination section that determines whether a device is a supporting target in managing a software product installed in the device, a display that displays an item indicating the software product in both a case where it is determined that the device is a supporting target and a case where it is determined that the device is not a supporting target, and an operation controller that receives plural types of user operations with respect to a supporting-related product which is a software product installed in the device in a case where it is determined that the device is a supporting target, and restricts reception of all or some of the plural types of user operations with respect to an out-of-supporting-related product which is a software product installed in the device in a case where it is determined that the device is not a supporting target.

### CROSS-REFERENCE TO RELATED APPLICATIONS

This application is based on and claims priority under 35 USC 119 from Japanese Patent Application No. 2017-170343 filed Sep. 5, 2017.

### BACKGROUND

### (i) Technical Field

The present invention relates to a software management device, a software management system, and a non-transitory computer readable medium storing a program for software management.

### (ii) Related Art

Software management systems are systems that manage software which is installed or to be installed in a device to be subjected to software management (hereinafter, also referred to as a “software product” or simply a “product” as occasion demands). For example, installation, updating, or uninstallation of software is managed by the system, and a license to the software is managed.

In offices and the like, plural image forming devices connected to a network are used. Software providing an expansionary function required by a user may be installed afterwards (in advance in some cases) with respect to each of the image forming device. The realization of software management systems capable of integrally or unitarily managing such a software group has been expected.

### SUMMARY

According to an aspect of the invention, there is provided a software management device including a determination section that determines whether or not a device is a supporting target in managing a software product installed in the device, a display that displays an item indicating the software product in both a case where it is determined that the device is a supporting target and a case where it is determined that the device is not a supporting target, and an operation controller that receives plural types of user operations with respect to a supporting-related product which is a software product installed in the device in a case where it is determined that the device is a supporting target, and restricts reception of all or some of the plural types of user operations with respect to an out-of-supporting-related product which is a software product installed in the device in a case where it is determined that the device is not a supporting target.

### BRIEF DESCRIPTION OF THE DRAWINGS

Exemplary embodiment(s) of the present invention will be described in detail based on the following figures, wherein:

FIG. 1 is a block diagram illustrating a software management system according to an exemplary embodiment;

FIG. 2 is a diagram illustrating an example of a case where an out-of-supporting-related product is generated;

FIG. 3 is a block diagram illustrating a configuration example of an image forming device illustrated in FIG. 1;

FIG. 4 is a block diagram illustrating a configuration example of an information management server illustrated in FIG. 1;

FIG. 5 is a diagram illustrating a configuration example of a user information table;

FIG. 6 is a diagram illustrating a configuration example of a product information table;

FIG. 7 is a block diagram illustrating a configuration example of a software management device illustrated in FIG. 1;

FIG. 8 is a diagram illustrating an example of information provided from the information management server;

FIG. 9 is a diagram illustrating another configuration example of an installer file;

FIG. 10 is a diagram illustrating an example of information provided from the image forming device;

FIG. 11 is a flowchart illustrating an example of an operation of displaying an installed product list;

FIG. 12 is a diagram illustrating display conditions;

FIG. 13 is a diagram illustrating operation control conditions;

FIG. 14 is a diagram illustrating a first example of a displayed image;

FIG. 15 is a diagram illustrating a second example of a displayed image; and

FIG. 16 is a diagram illustrating a management table for out-of-supporting-related products.

### DETAILED DESCRIPTION

Hereinafter, an exemplary embodiment of the invention will be described with reference to the accompanying drawings.

### 1. Overall Description

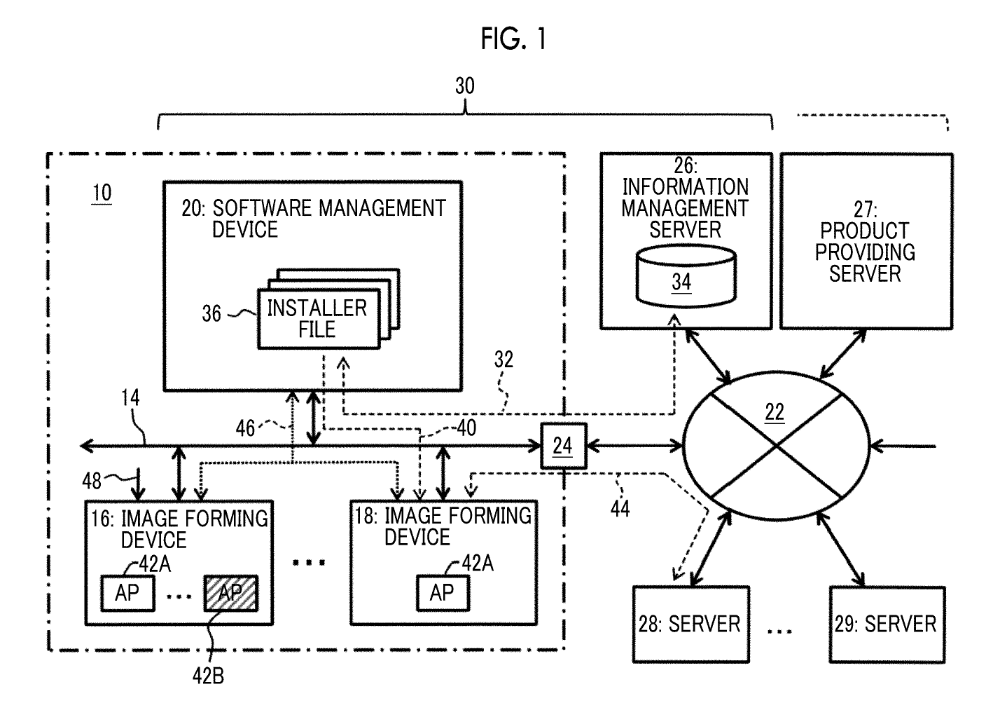

FIG. 1 illustrates a software management system according to the exemplary embodiment. The software management system is a system that integrally or unitarily manages a software product group which is installed or to be installed in one or plural devices. Typically, each software product is an application program installed in a device in order to expand a function of the device. Naturally, a software product which is installed in the device from the beginning may be an object to be managed. The software product is a software commodity from a point of view of buying and selling. Hereinafter, a software product may be simply referred to as a “product”.

In the software management system according to the exemplary embodiment, a device having a software product installed therein is an image forming device. The image forming device is a so-called multifunction machine having plural document processing functions such as a scanner function, a copying function, a printing function, and a facsimile function. The concept of the image forming device also includes a device having one document processing function. A software product installed in another device, such as a general-purpose information processing device or a terminal device for a specific use, may be managed by the software management system.

In the configuration example illustrated in FIG. 1, a Local Area Network (LAN) 14 is provided in an office 10. The office 10 is an example, and an institution provided with the LAN 14 may be a public institution, a school, and the like. Plural image forming devices 16 and 18 are connected to the LAN 14, as plural devices to be subjected to software management. Each of the image forming devices 16 and 18 has one or plural document processing functions as described above. An image forming device including a finishing unit that performs folding processing, staple processing, and the like may be connected to the LAN 14.

In the configuration example illustrated in the drawing, plural software products (AP) 42A and 42B are installed in the image forming device 16, and the software product (AP) 42A is installed in the image forming device 18. In this manner, the same software product 42A may be installed in the plural image forming devices 16 and 18. Here, the software product 42B is an “out-of-supporting-related product”.

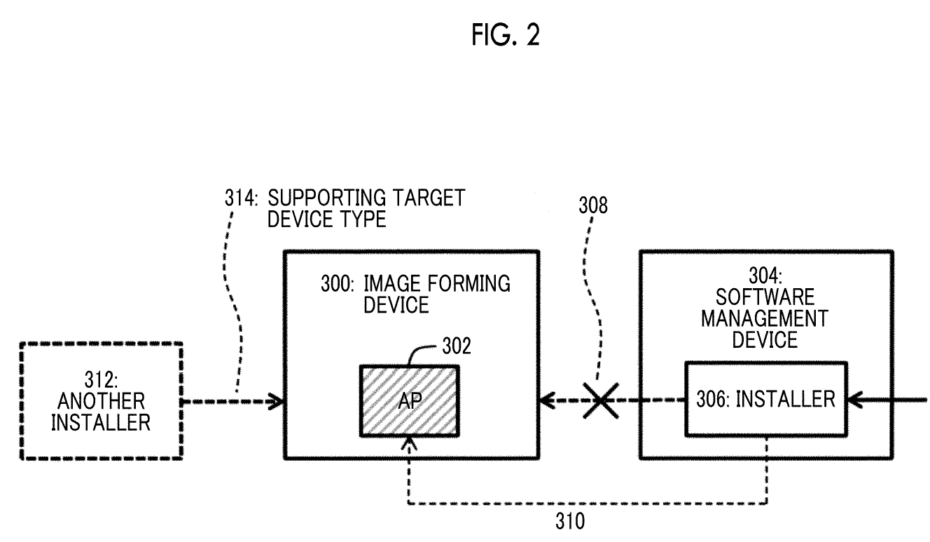

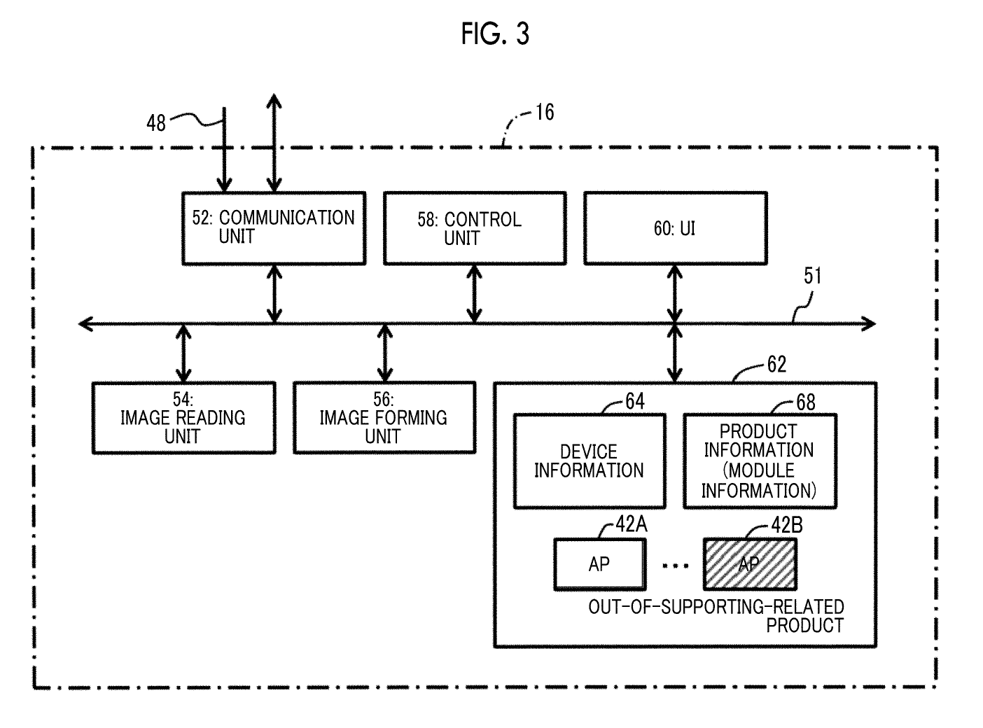

In the exemplary embodiment, the out-of-supporting-related product is a software product which is recognizable in the software management device 20, and is a product installed in an image forming device which is not set to be a supporting target by a corresponding installer (that is, which is excluded from a supporting target). The cause of generation of the out-of-supporting-related product, and the like will be described later with reference to FIG. 2. A specific configuration of each of the image forming devices 16 and 18 will be described later with reference to FIG. 3.

Meanwhile, in the comparison with an out-of-supporting-related product, the software product 42A installed in the image forming device which is not set to be a supporting target by the installer may be referred to as a “supporting-related product”.

The software management device 20 according to the exemplary embodiment is a device for managing a software product group which is installed or to be installed in the plural image forming devices 16 and 18. The software management device 20 is connected to the LAN 14. The software management device 20 executes or manages the downloading, installation, updating, uninstallation, and the like with respect to each of software products which are used in the plural image forming devices 16 and 18. Such processing is performed in accordance with information provided from an information management server 26 to be described later. The out-of-supporting-related product 42B may be an object to be displayed in the software management device 20, but a user operation for updating and uninstalling the out-of-supporting-related product 42B is restricted in the software management device 20. This will be described later in detail.

The software management device 20 is constituted by, for example, a personal computer (PC) as an information processing device. The software management device may be constituted by a portable terminal device or the like. The software management device 20 may be constituted by plural PCs. In the exemplary embodiment, the software management device 20 is configured as a device which is separate from a device to be subjected to software management.

The software management device 20 according to the exemplary embodiment has a function of displaying a product list. As the product list, an installed product list, a usable product list, a purchased product list, and the like may be displayed. The installed product list may include an item indicating an out-of-supporting-related product specified in the software management device 20 as described later.

The LAN 14 is connected to the Internet 22 as an external network through a connection apparatus 24. The connection apparatus 24 is constituted by a bridge, a router, a gateway, or the like. The information management server 26 and a product providing server 27 are connected to the Internet 22 in the configuration example illustrated in the drawing, and some servers 28 and 29 are connected to the Internet.

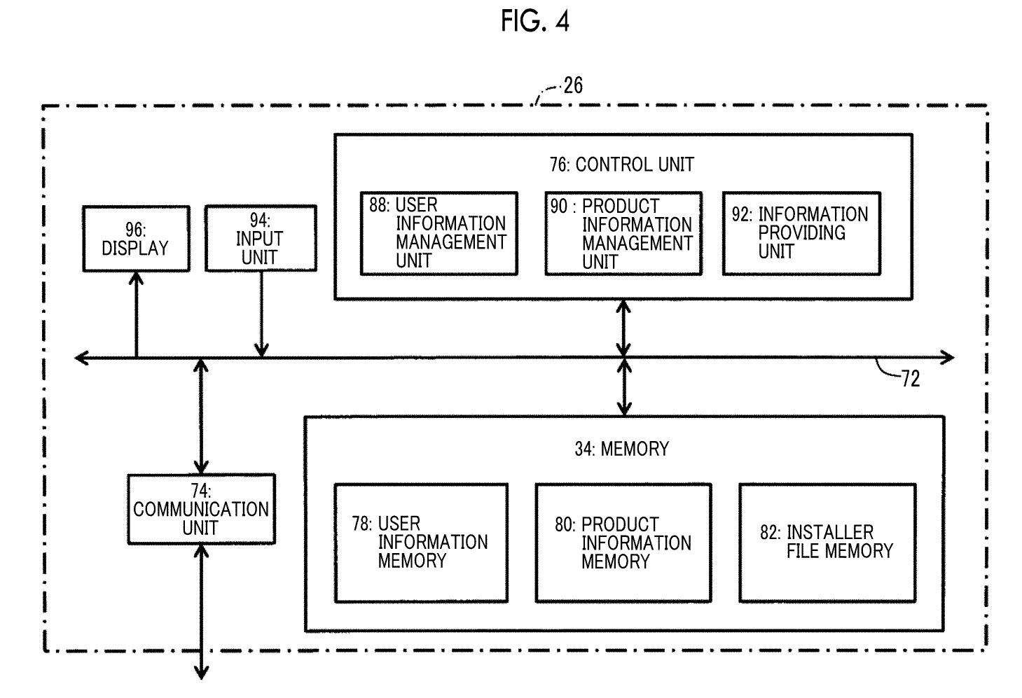

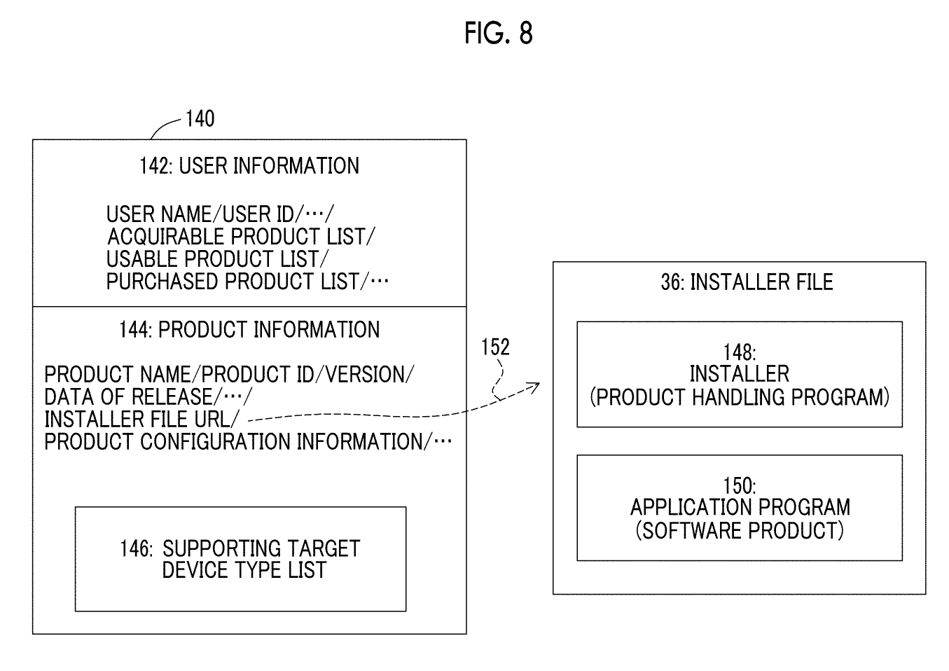

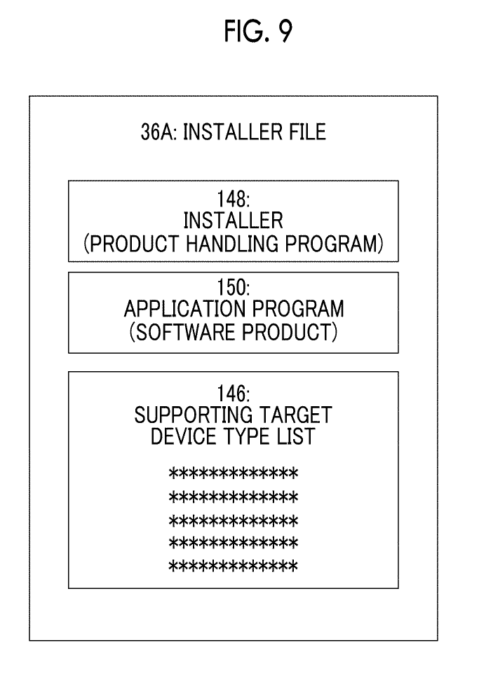

The information management server 26 manages information necessary for managing each software product in the software management device 20, and specifically, user information, license information, product information, and other information, and provides information necessary in the functioning of the information management server with respect to the software management device 20. The necessary information includes information necessary in displaying the product list, information necessary in managing a license, and the like in the software management device 20. The information management server 26 also has a function of providing an installer file corresponding to each software product or information indicating the location of the installer file to the software management device 20. Each installer file includes a software product, an installer, a supporting target device type list, and the like, as illustrated in FIGS. 8 and 9 to be described later. The information management server 26 includes a memory 34 that functions as a database. A specific configuration of the information management server 26 will be described later in detail with reference to FIGS. 4 to 6.

The software management system 30 according to the exemplary embodiment is constituted by, for example, the software management device 20 and the information management server 26. The devices 20 and 26 may be formed integrally. The software management system 30 may include the product providing server 27 to be described later.

The product providing server 27 is a device that that sells a pay software product (pay product) on-line, and specifically, has a function of performing charging processing on a pay product, a function of delivering the pay product through a network, and the like. The product providing server 27 according to the exemplary embodiment also has a function of delivering a free software product (free product) through a network. In the configuration example illustrated in the drawing, the information management server 26 and the product providing server 27 are operated in association with each other at the time of the selling of a pay product or the provision of a free product. A user may acquire and use a desired product without being especially conscious of which device is accessed, on the condition that a certain condition, such as user registration, is satisfied. Meanwhile, the product providing server 27 may be embedded into the information management server 26. On the contrary, the information management server 26 may be embedded into the product providing server 27. Each of the information management server 26 and the product providing server 27 may be constituted by one or plural information processing devices.

Each of the servers 28 and 29 is a device that provides a certain service in cooperation with corresponding software products installed in the image forming devices 16 and 18. Examples of such a service include a document storage service and the like. A software product for requesting a service may be referred to as client software. Naturally, software products to be installed in the image forming devices 16 and 18 may also include a software product which individually functions without requiring the provision of a service by the server. Examples of such a software product include a software product enabling a collective operation by packaging plural user operations.

In a case where a user performs an operation of designating and purchasing a specific pay product on-line in a state where the user logs on the software management system 30, charging processing, the registration of license information, and the like are executed in accordance with the operation (see reference numeral 32). Subsequently, in a case where the user performs a downloading operation, an installer file for installing a purchased product is transmitted to the software management device 20 from the information management server 26 or the product providing server 27 (the same). The downloaded installer file is stored in the software management device 20. With regard to a free product, a corresponding installer file is stored in the software management device 20 through the above-described process. In the configuration example illustrated in the drawing, a downloaded installer file is denoted by reference numeral 36.

In a case where a user designates an image forming device (for example, the image forming device 18) as an installation destination and performs an installation operation on a software product in the software management device 20, an installer within the installer file 36 functions, so that a software product within the installer file 36 is transmitted to the image forming device designated as an installation destination and is installed in the image forming device (see reference numeral 40). Therefore, the software product functions in an image processing device which is an installation destination. For example, the software product is operated in association with a server (for example, the server 28) (see reference numeral 44). The software management device 20 has a function of creating and displaying an installed product list in retrieving and specifying a software product group installed in plural image forming devices (see reference numeral 46).

Meanwhile, the user is a person having an account capable of logging on the software management system 30 and is a user of the software management system 30, and the user may include a purchaser of a pay product and an acquisitor of a free product. In this manner, the user is conceptually different from a user of an image forming device. Meanwhile, the purchase, management, and the like of a software product are performed in units of user groups.

### 2. Cause of Generation of Out-of-Supporting-Related Product

A general description of the cause of generation of an out-of-supporting-related product will be given with reference to FIG. 2. A software product 302 is installed in an image forming device 300. An installer 306 within a software management device 304 is an installer for the software product 302 within the image forming device 300, and the installer 306 does not set the image forming device 300 as a supporting target. For this reason, a situation is given where the maintenance (updating, uninstallation, and the like) of the software product 302 may not be performed by the installer 306. This is the same as in a case where appropriate processing is not secured even in a case where maintenance may be actually performed. That is, the image forming device 300 is an out-of-supporting-target device type 308 in a case of being seen from the installer 306, and a supporting relation is not established between the image forming device and the installer. In this case, it may be said that the software product 302 is an out-of-supporting-related product 310 in a case of being seen from the installer 306.

For example, in a case where a user or a customer engineer installs the software product 302 in the image forming device 300 by using another installer (typically, an installer having a different version) 312 without going through the software management device 304, the out-of-supporting-related product 310 may be generated. For example, in a case where the image forming device 300 is a new device type and the installer 306 does not set the new device type as a supporting target, the software product 302 serves as the out-of-supporting-related product 310 in a case of being seen from the installer 306. The software product 302 may be installed in a new device type.

Also in a case where a former installer equivalent to a predecessor of the installer 306 is replaced with the installer 306 by updating or the like after the software product 302 is installed by the former installer (after the software product is installed by the software management device 304) and the image forming device 300 is excluded afterwards from a supporting target range at the time of the replacement, the software product 302 serves as the out-of-supporting-related product 310 in a case of being seen from the installer 306. In this case, the former installer is equivalent to another installer described above. The out-of-supporting-related product 310 may be generated by other causes.

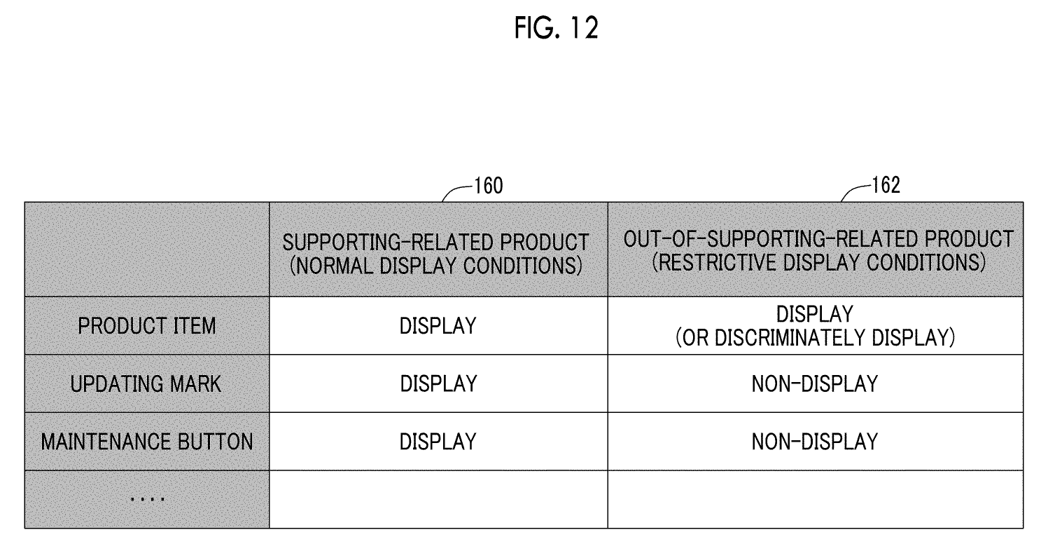

In the software management by the software management device 304, in a case where an out-of-supporting-related product is not displayed in the installed product list at all even though a user operation with respect to an out-of-supporting-related product may not be received, variance may occur between an actual installation state and displayed contents, which may result in the user's uneasiness, misunderstanding, or the like in some cases. Based on this situation, the out-of-supporting-related product restricts a user operation and serves as an object to be displayed in this exemplary embodiment. In other words, corresponding display conditions and operation control conditions are applied to each of the supporting-related product and the out-of-supporting-related product. The display conditions and the operation control conditions will be described later with reference to FIG. 12 and the subsequent drawings.

### 3. Description of Image Forming Device

FIG. 3 illustrates a configuration example of the image forming device 16. Meanwhile, the image forming device 18 illustrated in FIG. 1 has the same configuration as that of the image forming device 16.

In FIG. 3, a communication unit 52, an image reading unit 54, an image forming unit 56, a control unit 58, a User Interface (UI) 60, and the like are connected to an internal bus 51. The communication unit 52 is connected to a LAN. The image reading unit 54 reads a physical document to generate an electronic image (electronic document) of the physical document. The image forming unit 56 prints the electronic document on a sheet. The control unit 58 is equivalent to a CPU and various programs. The UI 60 is constituted by, for example, a Liquid Crystal Display (LCD) with a touch sensor. A memory 62 stores device information 64 and product information 68. Further, the plural installed software products (AP) 42A and 42B are stored. For example, the software product 42A is executed on the control unit 58, and thus a service based on the software product 42A is provided. In the example illustrated in the drawing, the software product 42B is an out-of-supporting-related product. The software product 42B is also executed on the control unit 58 as long as a certain condition is satisfied, and a service based on the software product 42B is provided.

The device information 64, which is information for specifying the device type of the image forming device 16, includes, for example, a device type ID. The device information 64 may include information indicating an installation location of the image forming device 16. The product information 68, which is information for specifying each software product installed, includes, for example, a product ID.

The software management device according to the exemplary embodiment has a function of specifying each product from a module configuration of each product even in a case where an ID of each product may not be acquired from the image forming device 16. In a case where such a function is used, information (module information) indicating a module configuration is stored in the image forming device 16 as the product information 68. The module information is prepared for each product, and is information for specifying one or plural modules (components) constituting the product. Specifically, the module information includes a module ID, a version, and the like. Even in a case of the out-of-supporting-related product 42B, a product name or a product ID may be specified based on the module information. Naturally, the specification of the product based on the module information is just an example.

### 4. Description of Information Management Server

FIG. 4 illustrates a configuration example of the information management server 26. A communication unit 74, a control unit 76, a memory 34, an input unit 94, a display unit 96, and the like are connected to an internal bus 72. The memory 34 functions as a database as described above, and specifically, includes a user information memory 78, a product information memory 80, and the like. Further, in the configuration example illustrated in the drawing, the memory 34 further includes an installer file memory 82.

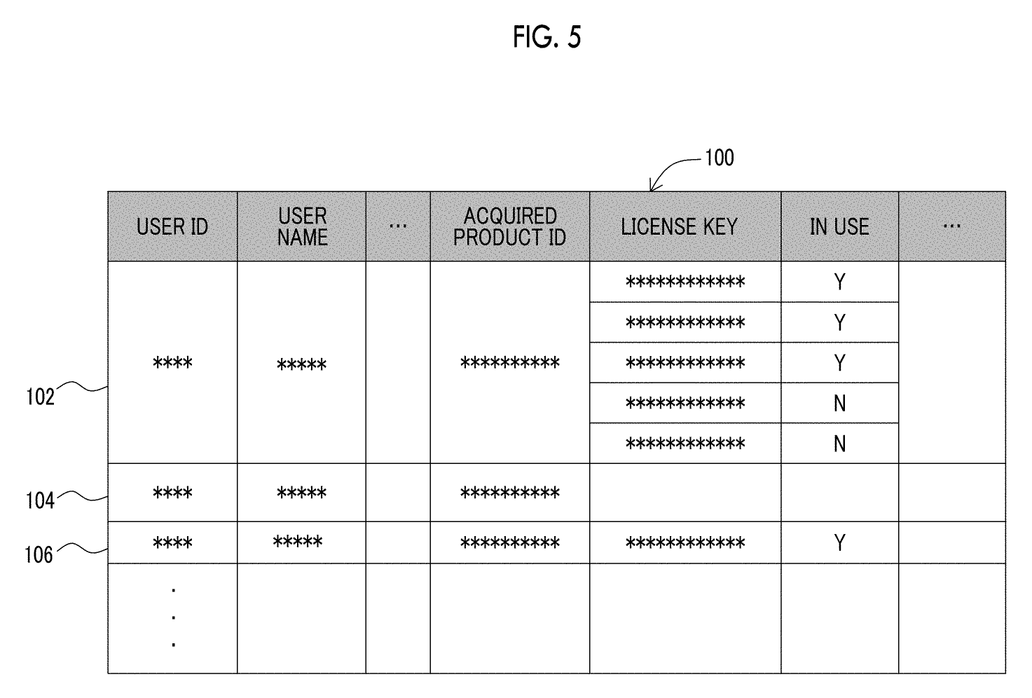

User information is stored in the user information memory 78 in units of users. The user information includes information for specifying a user, and further includes license information. The license information may be associated with the user information instead of being included in the user information. The user information will be described later with reference to FIG. 5.

The license information includes, for example, information for specifying a purchasing user, information for specifying a pay product to be subjected to licensing, and information indicating use conditions and a use state with respect to the pay product. For example, the number of installable times (total), the number of times of installation having been executed so far (actual results), the number of times of installation which is executable from now on (remaining number), and the like may be specified. A product may be managed in accordance with the number of users who use the product or the number of devices that install the product. In addition, the license information may include license keys in units of installation.

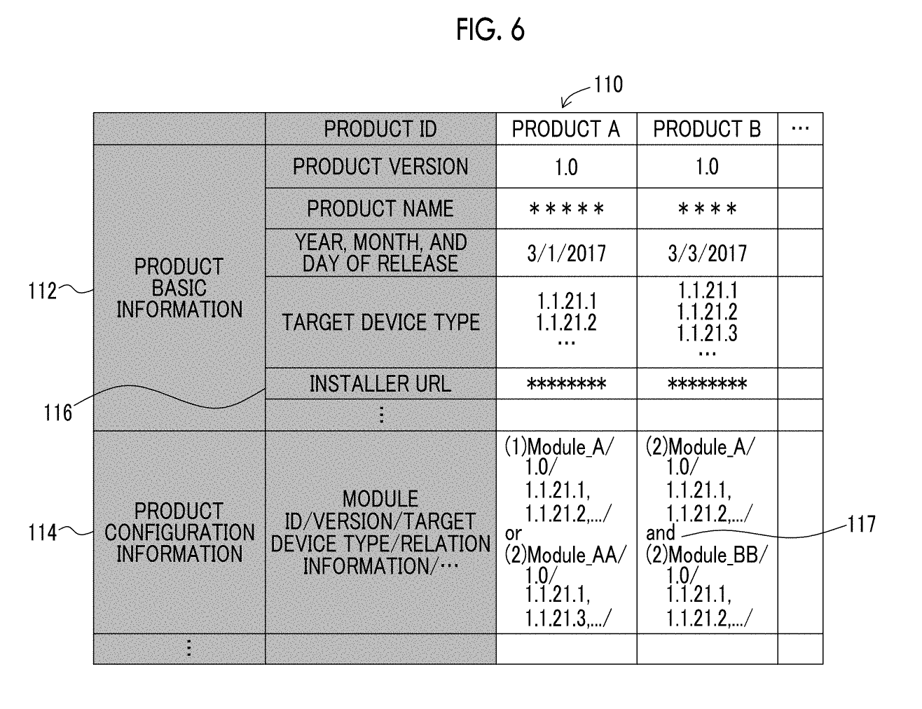

The product information memory 80 stores product information for each product. The product information includes product basic information, product configuration information (module information), and the like. This will be described later with reference to FIG. 6.

The installer file memory 82 is provided within the information management server 26 as necessary. The installer file memory 82 stores, for example, plural installer files corresponding to plural products. Each of the installer files is a file in which plural program and data are packaged. The installer file memory 82 may be provided in a device such as a product providing server.

The control unit 76 is constituted by a CPU and various programs. In FIG. 4, plural functions of the control unit 76 are illustrated as plural blocks. A user information management unit 88 is a module that registers user information for each user and manages the registered user information. The user information management unit 88 may exhibit a user authentication function. A user authentication unit may be provided separately. The user information stored in the user information memory 78 is referred to during the user authentication.

A product information management unit 90 is a module that registers product information for each product and manages the registered product information. The information providing unit 92 is a module that extracts and integrates information necessary in performing the management of a software product in the software management device and provides the information to the software management device. The provided information includes, for example, user information, usable product list information, and the like. Further, license information is included. The license information may be provided as a portion of the user information or a portion of the usable product list information.

FIG. 5 illustrates an example of a user information table stored in a user information memory. In the configuration example illustrated in the drawing, a user information table 100 includes plural records 102, 104, and 106. Each of the records 102, 104, and 106 includes plural pieces of information, and each of the records includes, for example, a user ID, a user name, an acquired product ID, one or plural license keys, a code (Y/N) indicating whether or not a product has been used for each license key, and the like. For example, a permitted number of license keys are issued based on the license information. The license key is required at the time of the installation of a product. In the example illustrated in the drawing, a license key is not associated with respect to a free product. More detailed license information (a license mode, a validity period, and the like) may be managed on the user information table 100.

FIG. 6 illustrates a configuration example of a product information table. A product information table 110 illustrated in the drawing is stored on a product information memory in an information management server. The product information table 110 substantially includes product basic information 112 and product configuration information 114. The product basic information 112 includes a product ID, a version, the year, month, and day of release, a target device type list, and the like for each product. The target device type list is information for specifying one or plural device types that may serve as an installation destination of the product, and specifically, includes one or plural device type IDs. The product basic information 112 includes a Uniform Resource Locator (URL) 116 of an installer file.

The product configuration information 114 is information for specifying a module configuration for each product. One or plural pieces of module information are managed for each product, and relation information (see reference numeral 117) for specifying a correlation between plural modules is also managed. Examples of the correlation include an “or” relation, an “and” relation, an inclusion relation, and the like. Specifically, the module information is constituted by a module ID, a version, a target type list, and the like in the example illustrated in the drawing. In the software management device, one or plural products installed in the image forming device are specified by butting the product configuration information for each product which is received from the information management server and the module information received from the image forming device. Naturally, in a case where a product ID of a product installed in the image forming device is managed on the image forming device, the product ID may be referred to.

### 5. Description of Software Management Device

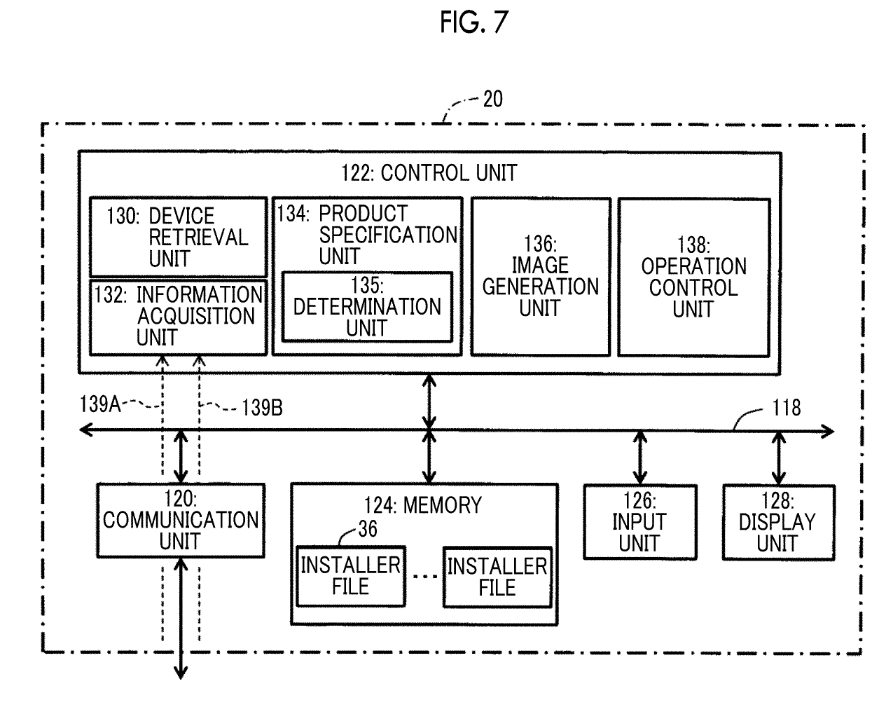

FIG. 7 illustrates a configuration example of a software management device. The software management device 20 includes an internal bus 118, and a communication unit 120, a control unit 122, a memory 124, an input unit 126, a display unit 128, and the like are connected to the internal bus 118. The communication unit 120 connects a LAN and the internal bus 118 to each other. The control unit 122 is equivalent to a memory that stores a CPU and various programs (including a software management program). The various programs may be stored in the memory 124 to be described below.

The memory 124 stores the downloaded installer file 36 and the like. Information 139A acquired from each image forming device and information 139B acquired from the information management server are also stored in the memory 124 as necessary. An input unit 168 is constituted by an input device such as a keyboard or a mouse. A display unit 170 is constituted by a display such as an LCD. The display unit 170 functions as a display that displays an item indicating an out-of-supporting-related product.

In FIG. 7, plural functions of the control unit 122 are illustrated as plural blocks. The device retrieval unit 130 specifies one or plural image forming devices (devices) which are connected to the LAN in accordance with retrieval conditions. As the retrieval conditions, a retrieval range (for example, a locational range) may be determined. The information acquisition unit 132 acquires device information and product information from each image forming device which is specified by retrieval (see reference numeral 139A). The device information is, for example, a device ID. The product information is information for specifying each product installed, and specifically, is module information for specifying a product. The information acquisition unit 132 also acquires user information, product configuration information, and the like which are provided from the information management server (see reference numeral 139B).

The product specification unit 134 specifies one or plural products installed in the image forming device by butting the module information acquired for each product and the product configuration information of each product which is obtained from the information management device. For example, in a case where a combination of two module IDs with respect to two modules constituting the installed product and a combination of two module IDs with respect to a specific product defined in the product configuration information are consistent with each other, the installed product is determined to be the specific product. Naturally, in a case where a product ID may be acquired as product information from each image forming device, it is not necessary to perform such butting processing. Meanwhile, a list of usable products for each user is managed, and the specification of installed product is performed on a product which is usable by each user. Naturally, all of the installed products may be specified.

The product specification unit 134 includes a determination unit 135 in the configuration example illustrated in the drawing. The determination unit 135 determines whether or not an image forming device including a specified product is a supporting target of an installer corresponding to the product, for each product specified. This determination is equivalent to determination regarding whether each product is a supporting-related product or an out-of-supporting-related product. In this case, a supporting target device type list within each installer file 36 is referred to in the exemplary embodiment.

The image generation unit 136 functions as an image generation section or a display processing section. The image generation unit 136 generates an installed product list and the like, as a product list. The installed product list is installed in a selected image forming device, and includes one or plural items indicating one or plural products specified by the product specification unit 134. The installed product list may include an item indicating an out-of-supporting-related product in the exemplary embodiment. In addition, the image generation unit 136 generates a usable product list and the like based on the information 139B obtained from the information management server.

The operation control unit 138 receives a user operation with respect to a product, and executes a command given by the user operation. Plural types of user operations to be received include an operation of downloading an installer file, an operation of installing a software product, an operation of updating the product, and an operation of uninstalling the product in the exemplary embodiment. With regard to the supporting-related product installed in the image forming device, an operation of updating the product and an operation of uninstalling the product may be performed on the software management device 20. That is, all operations capable of being performed under the situation are received.

On the other hand, with regard to an out-of-supporting-related product installed in the image forming device, an operation of updating the product and an operation of uninstalling the product are all set to be an out-of-reception target on the software management device 20. In fact, with regard to the out-of-supporting-related product, an item indicating the out-of-supporting-related product is displayed, but an operation button corresponding to the item is not displayed. Alternatively, the operation button corresponding to the item is displayed in a mode such as a semitransparency mode, and an operation therefor is set to be an out-of-reception target. In any case, the updating operation and the uninstallation operation are restricted. Naturally, with regard to the out-of-supporting-related product, only the uninstallation operation (that is, a portion of operations) may be admitted.

In this manner, the operation control unit 138 may make display conditions and operation control conditions different depending on whether a product to be displayed is a supporting-related product or an out-of-supporting-related product.

### 6. Description of Operations and the Like

Prior to a description of a specific operation example, a specific example of information acquired in the software management device will be described.

FIG. 8 illustrates an example of information provided from an information management server to a software management device in accordance with a request from the software management device. A server response information 140 illustrated in the drawing includes user information 142 and product information 144. The user information 142 is information on a login user for which user authentication has been completed, and includes a user name, a user ID, various product lists, and the like in the configuration example illustrated in the drawing. The various lists include a list of products which are usable by the login user. In addition, a list of products which are acquirable by the login user, a list of products that have already been purchased by the login user, and the like may be included. The product information 144 is information on a product which is usable by a user, and the product information 144 includes a product name, a product ID, a version, the date of release, and the like, and includes an installer file URL, product configuration information, and the like. In the configuration example illustrated in the drawing, the product information 144 includes a supporting target device type list 146 in units of products.

In the software management device, the installer file 36 is acquired based on the installer file URL (see reference numeral 152). The installer file 36 includes an installer 148 as a product handling program and an application program 150 as a software product. The installer 148 is a program which is executed in the software management device, and the installer 148 has a remote installation function, a remote updating function, and a remote uninstallation function. That is, the application program 150 is installed in an image forming device serving as a supporting target by the installer 148. Therefore, maintenance and the like are performed on the application program 150 by the installer 148. In a case where determination regarding whether being a supporting target is performed, the supporting target device type list 146 is referred to.

On the other hand, as illustrated in FIG. 9, each installer file 36A may include the supporting target device type list 146. The supporting target device type list 146 is inseparable from the installer 148, and thus rationality is recognized for an integral configuration illustrated in FIG. 9. In the exemplary embodiment, the installer 148 and the application program 150 are executable programs.

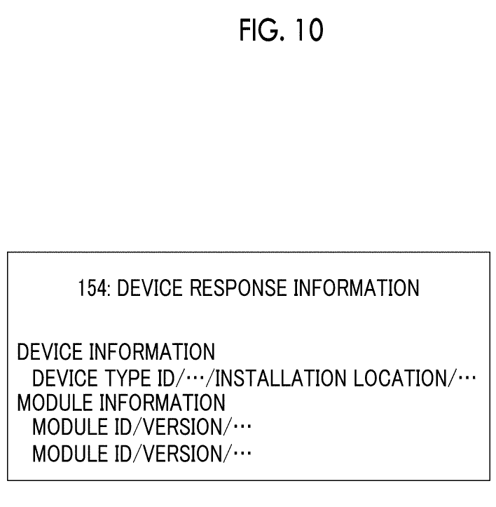

FIG. 10 illustrates an example of information provided from each image forming device to a software management device in accordance with a request from the software management device. The information is device response information 154, and includes device information and module information in the example illustrated in the drawing. The device information includes a device type ID, installation location information, and the like. The module information includes a module ID, a version, and other information for each module constituting each product.

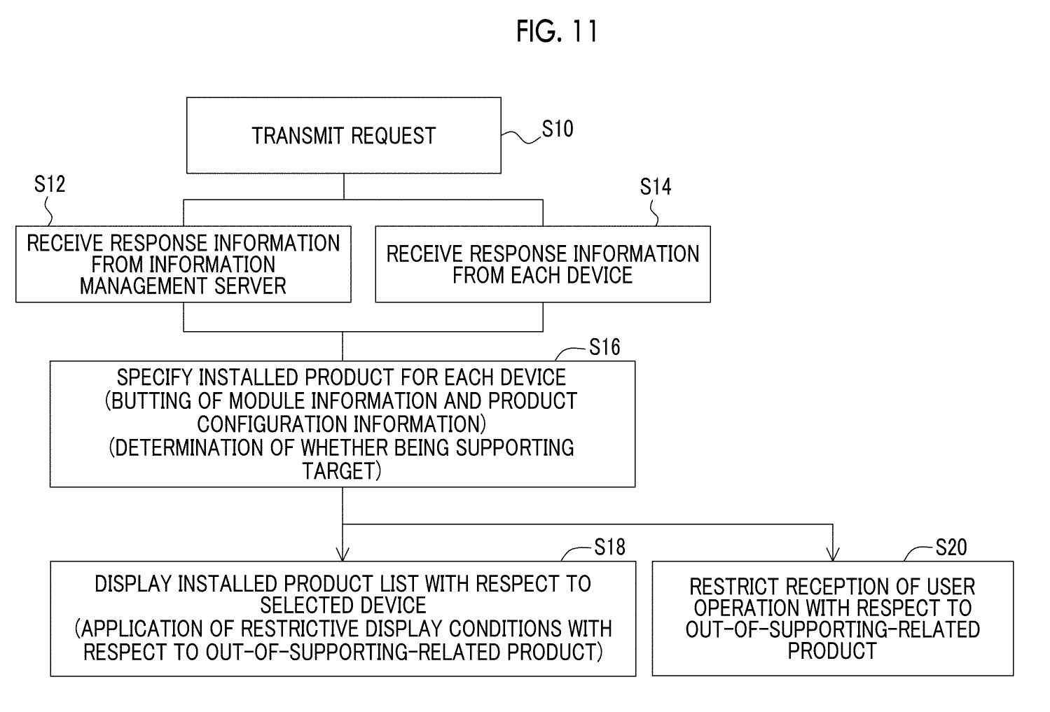

In FIG. 11, an operation example of a software management device is illustrated as a schematic flowchart. The operation example is an operation example in a case where an installed product list is displayed.

In S10, a request for the transmission of information is issued with respect to the information management server and each image forming device (device) searched for by retrieval, based on a user's predetermined operation. In S12, response information (see, for example, FIG. 8) from the information management server is received. In S14, response information (see, for example, FIG. 10) from each image forming device is received. Here, S12 and S14 are executed in parallel or in order.

In S16, a product which is installed and usable by the user is specified for each image forming device. In this case, a process of butting module information obtained from each image forming device and product configuration information obtained from the information management server is executed, if necessary. In S16, it is also determined whether or not an image forming device including a specified product is a supporting target of an installer of the product, for each product specified. In a case where the image forming device is a supporting target, the product is set as a supporting-related product on the software management device. In a case where the image forming device is not a supporting target, the product is set as an out-of-supporting-related product on the software management device. Subsequently, S18 and S20 are executed in parallel or in order.

In S18, an installed product list is generated and displayed with respect to an image forming device selected by the user. Typically, the installed product list includes one or plural items (displayed elements) which indicate one or plural products. In a case where the installed product list includes an item indicating an out-of-supporting-related product, restrictive display conditions are applied with respect to the item. Normal display conditions (nonrestrictive display conditions) are applied with respect to an item indicating a supporting-related product.

In S20, the reception of a user operation with respect to an out-of-supporting-related product is restricted. Specifically, an updating operation and an uninstallation operation which are recognized with respect to a supporting-related product are not recognized, and a button for performing the operations is also not displayed. Here, S18 is equivalent to a display step or a display control step, and S18 is equivalent to an operation control step. Naturally, only the uninstallation operation may be recognized on the assumption that the software management device is provided with a general-purpose or dedicated program for uninstallation. That is, only a portion of operations among plural types of operations recognized with respect to the supporting-related product may be received.

FIG. 12 illustrates the display conditions applied in S18. As indicated by reference numeral 160, normal display conditions are applied with respect to a supporting-related product. That is, as described later by using an image example, an item indicating a product, an updating mark, a maintenance button and the like are all displayed. The maintenance button is operated at the time of displaying an updating operation button and an uninstallation operation button.

On the other hand, as indicated by reference numeral 162, restrictive display conditions are applied with respect to an out-of-supporting-related product. An item indicating a product is displayed, but an updating mark and a maintenance button are not displayed. Naturally, the maintenance button may be displayed, and the function thereof may be invalidated. A display mode of an item indicating an out-of-supporting-related product may be made different from a display mode of a supporting-related product. That is, both the products may be discriminately expressed.

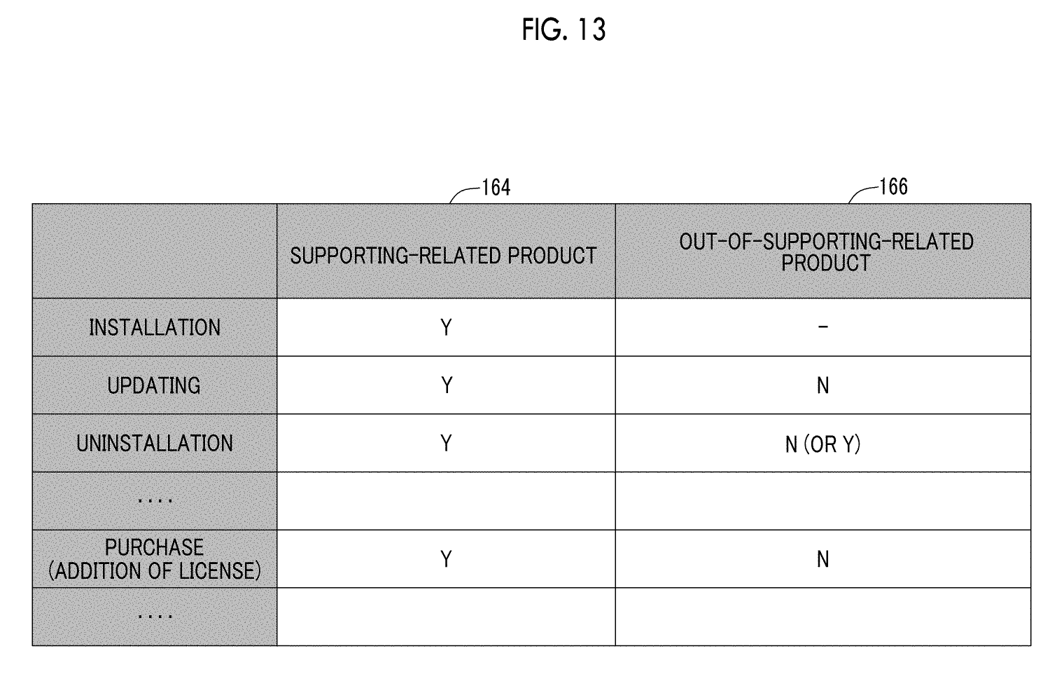

FIG. 13 illustrates operation control conditions applied in S20. As indicated by reference numeral 164, an installation operation, an updating operation, and an uninstallation operation are recognized with respect to a supporting-related product. Further, in a case of a pay product, an operation for additionally purchase a license, and the like are recognized under a certain condition. Here, the additional purchase of a license is the purchase of a right or a license key for additionally performing installation.

On the other hand, as indicated by reference numeral 166, an updating operation and an uninstallation operation are not recognized with respect to an out-of-supporting-related product which is installed in an image forming device. In a case where the out-of-supporting-related product is a pay product, an operation for additionally purchase a license is not also recognized. That is, with regard to the out-of-supporting-related product, all of plural types of operations recognized with respect to a supporting-related product are set to be out-of-reception targets. Naturally, a portion of the operations, for example, an uninstallation operation may be recognized. Meanwhile, the contents illustrated in FIG. 13 are given on the assumption that the out-of-supporting-related product has already been installed. Although it is not clearly shown in FIG. 13 whether or not an installation operation with respect to the out-of-supporting-related product can be performed, but an installation operation with respect to the out-of-supporting-related product cannot be performed, as a matter of course.

### 7. Description of Image

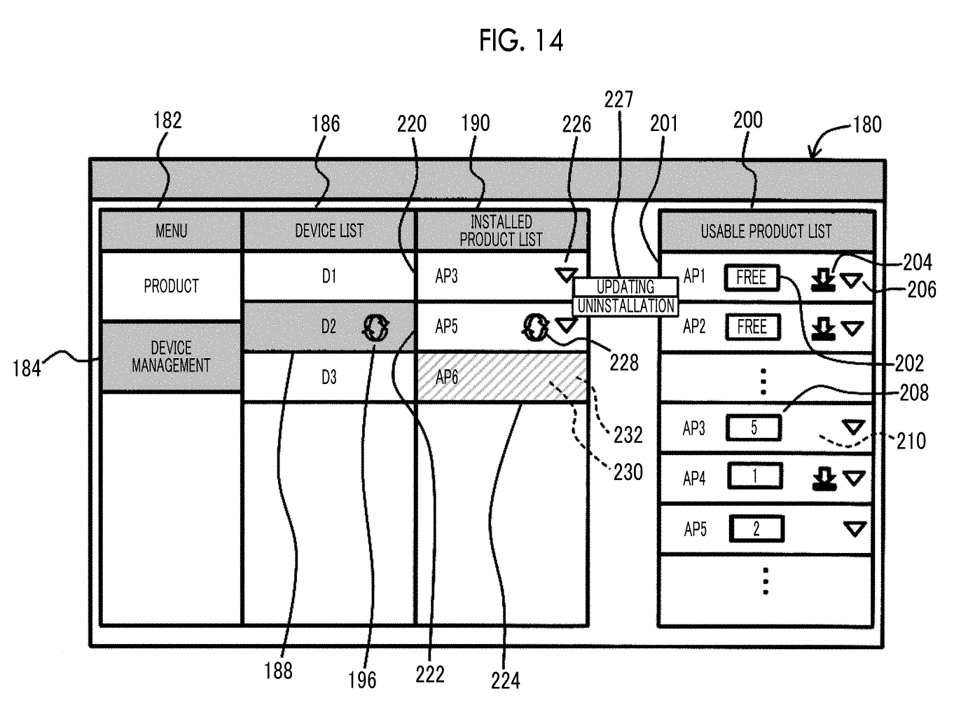

FIG. 14 illustrates a first example of an image displayed on a software management device. A menu column 182 is displayed on the left side of an image 180. The menu column 182 includes two items (buttons). In the example illustrated in the drawing, device management is selected as indicated by reference numeral 184. In response to this, a device list 186 is displayed on the left side of the menu column 182. The device list 186 includes plural items corresponding to plural image forming devices specified by retrieval. In the example illustrated in the drawing, an item 188 is selected, and an installed product list 190 is displayed on the right side of the device list. The installed product list includes plural items 220, 222, and 224 indicating plural installed products. Here, each of the items 220 and 222 corresponds to a supporting-related product, and the item 224 corresponds to an out-of-supporting-related product.

A maintenance button 226 displayed in each of the items 220 and 222 is a button which is operated or designated prior to updating and uninstallation operations, in a case where the updating and uninstallation operations are desired to be performed on an installed product. For example, in a case where the maintenance button 226 is clicked or a cursor is moved on the maintenance button 226, an operation button for updating and an operation button for uninstallation are pop-up displayed, as indicated by reference numeral 227.

An updating mark 228 displayed in the item 222 is a mark indicating that updating is required and recommended. In response to this, an updating mark 196 indicating that updating is required is also displayed in the item 188 indicating an image forming device.

The installed product list includes the item 224 corresponding to an out-of-supporting-related product, and thus the user can confirm or recognize the presence of the product. On the other hand, restrictive display conditions and restrictive operation control conditions are applied with respect to the out-of-supporting-related product. Specifically, in the example illustrated in the drawing, a maintenance button is not displayed (see reference numeral 232), and an updating button is not also displayed (see reference numeral 230) in the item 224 corresponding to the out-of-supporting-related product. Naturally, a maintenance button may be displayed in a mode such as a semitransparency mode. Alternatively, in a case where the maintenance button is displayed in a normal display mode and is then designated, the operation button for updating and the operation button for uninstallation may be displayed in a mode such as a semitransparency mode. In any case, an updating operation and an uninstallation operation are set to be out-of-reception targets with respect to the out-of-supporting-related product.

For example, it is preferable that a display mode of an item indicating a supporting-related product and a display mode of an item indicating an out-of-supporting-related product are made different from each other. For example, as illustrated in FIG. 14, the display color of the item 224 may be made different from the display color of the items 220 and 222.

Incidentally, a usable product list 200 is displayed on the left side of the image 180. The usable product list 200 includes plural items 201. In the example illustrated in the drawing, each item 201 corresponds to a pay product or a free product. A mark 202 indicates a free product. A button 204 is a downloading button. A button 206 is the above-described maintenance button. A numeral specified by reference numeral 208 indicates the number of licenses with respect to a pay product, and particularly, the number of remaining licenses (the number of installable times). In a case of a product for which downloading has been completed, a downloading mark is set to be in a non-display mode (see reference numeral 210).

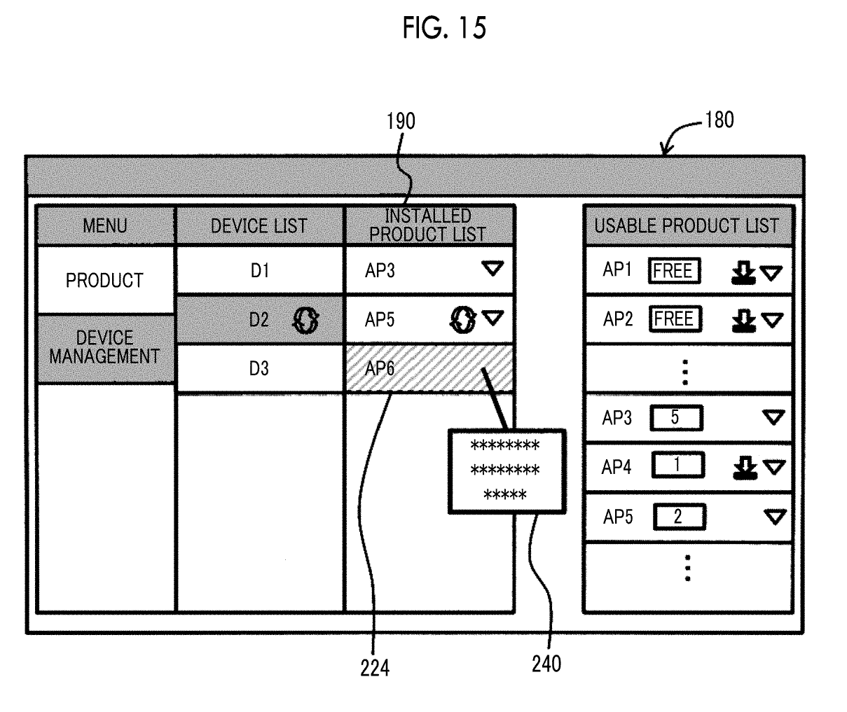

FIG. 15 illustrates a second example of an image displayed on a software management device. The installed product list 190 included in the image 180 includes the item 224 corresponding to an out-of-supporting-related product, similar to the above-described first example. In a case where the item 224 is clicked or is designated by a cursor, a pop-up window 240 is displayed in a format associated with the item 224. Among these, for example, a product is an out-of-supporting-related product of an installer, and a message indicating that the replacement of the product or the exchange of a device type is recommended is displayed. Other messages may be displayed.

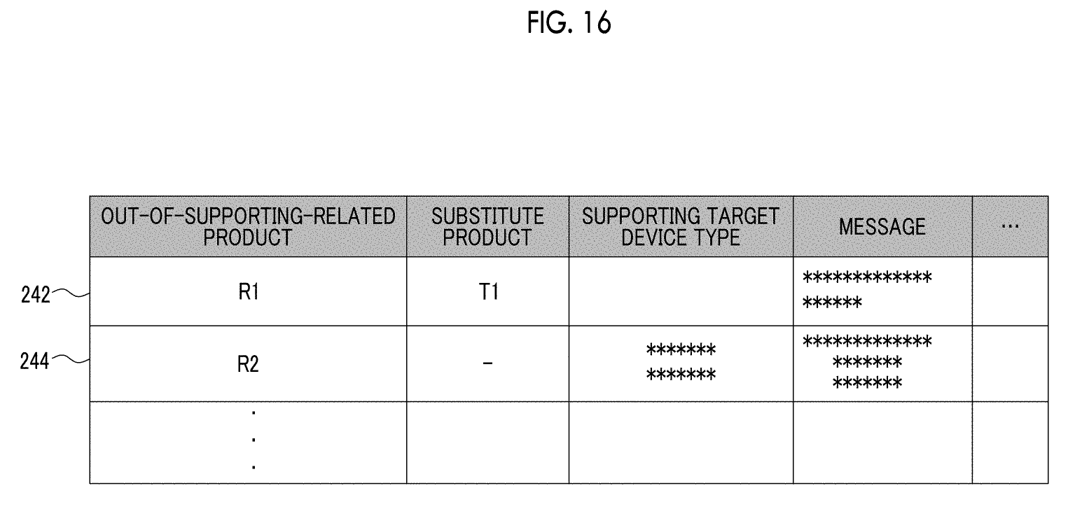

In a case where such display control is performed, a management table as illustrated in FIG. 16 may be provided in, for example, the software management device. The management table includes plural records 242 and 244, and each of the records 242 and 244 corresponds to an out-of-supporting-related product. Each of the records 242 and 244 includes the ID of the out-of-supporting-related product, information on a product (substitute product) which is substituted for the out-of-supporting-related product, a supporting target device type list, message information, and the like. For example, message information corresponding to the ID of the out-of-supporting-related product may be obtained with reference to the management table at the stage where the ID of the out-of-supporting-related product is specified, and the message may be provided to the user as described above. In addition, information on the substitute product and information on a substitute device type may be provided to the user.

### 8. Modification Example

Although an item corresponding to an out-of-supporting-related product is included in an installed product list in the above-described exemplary embodiment, the item may be displayed in another display column. A product list including only an item indicating a supporting-related product and a product list including only an item indicating an out-of-supporting-related product may be selectively or simultaneously displayed as the installed product list. A figure, a mark, a letter string, a sign, and the like may be adopted as a display mode of the item corresponding to the out-of-supporting-related product. An item corresponding to a device having an out-of-supporting-related product installed therein may be discriminately displayed in displaying a device list.

One image forming device may serve as an object to be subjected to software management. On the other hand, in a case where a large number of software products installed in plural image forming devices are managed by the software management device, it is possible to reduce burden on the user by integral or unitary management. An object to be subjected to software management may be a PC, a portable terminal, or the like.

In the exemplary embodiment, the information management server is connected to an external network, but the information management server may be connected to the same internal network together with the software management device. Alternatively, it is also considered that the software management device and the information management server are integrated with each other.

### 9. Arrangement of Disclosed Matters

This application discloses a software management device including a determination section, a display, and an operation controller. An example of the determination section is an out-of-supporting-related product determination section in the exemplary embodiment, an example of the display is a display unit in the exemplary embodiment, and an example of the operation controller is an operation control unit in the exemplary embodiment.

The above-described determination section is a section that determines whether or not a device is a supporting target in managing a software product installed in the device. In the exemplary embodiment, it is determined that the device is not a supporting target in a case where an installer corresponding to the software product installed in the device does not set the device as a supporting target. In addition, it may be determined that the device is not a supporting target in a case where the device is excluded from a supporting target due to any circumstances from a point of view of software management.

The above-described display is a section that displays an item indicating a software product in both a case where it is determined that the device is a supporting target and a case where it is determined that the device is not a supporting target. The item is a display element, and is displayed in a product list in the exemplary embodiment. The item may be displayed at a location other than the product list, or may be displayed as a single body.

The above-described operation controller receives plural types of user operations with respect to a supporting-related product installed in the device in a case where it is determined that the device is a supporting target, and restricts the reception of all or some of the plural types of user operations with respect to an out-of-supporting-related product installed in the device in a case where it is determined that the device is not a supporting target. The concept of the restriction of reception may include a mode in which an operation is invalidated even though the operation is performed, and a mode in which a button itself for an operation is not displayed. That is, as a result, the concept includes various modes in which an instruction based on an operation is not validated.

According to the above-described configuration, an item is also displayed with respect to an out-of-supporting-related product, and thus it is possible to make displayed contents consistent with the actual installation state and to bring the displayed contents close to the actual installation state. Thereby, it is possible to effectively prevent the user's uneasiness, confusion, misunderstanding, or the like. Even in a case where an item is displayed with respect to an out-of-supporting-related product, all or some of plural types of user operations recognized with respect to a supporting-related product is restricted with respect to the out-of-supporting-related product.

With a changed point of view, the above-described configuration is given on the assumption that determination regarding whether being a supporting-related product or an out-of-supporting-related product is performed, and different display conditions and different operation control conditions are applied to a supporting-related product and an out-of-supporting-related product in accordance with a result of the determination. Alternatively, in the above-described configuration, properties of a product are determined from a point of view of whether or not the product can be properly handled on the software management device side in a relationship with a device in which the product is installed, and control appropriate for the properties is executed.

In the exemplary embodiment, an installer remotely performs not only installation of a software product corresponding to the installer but also posterior maintenance (for example, updating and uninstallation) with respect to the same product. Naturally, the installer may have other functions.

An out-of-supporting-related product installed in a device is, for example, a software product installed in the device by an installer (second installer) which is separate from an installer (first installer) within the software management device, and updating and uninstallation cannot be performed on the out-of-supporting-related product by the installer within the software management device. For example, the first installer and the second installer are installers of the same product, but have different versions. Thereby, the installers have a relationship causing a difference in supporting target device type.

In addition, this application discloses a software management device including a determination section, a generation section, a display, and an operation controller. An example of the generation section is an image generation unit in the exemplary embodiment. The generation section is a section that generates a product list which includes an item indicating a software product and is displayed on the display. The generation section applies a first display condition with respect to a supporting-related product and applies a second display condition different from the first display condition with respect to an out-of-supporting-related product, in generating a product list. Different display conditions are applied to the supporting-related product and the out-of-supporting-related product, and thus misunderstanding, confusion, and the like in performing recognition or operation are prevented.

In addition, this application discloses a software management system including a software management device and a providing device. The software management device is a device for managing a software product which is installed in an image forming device. The providing device is a device which is connected to the software management device and provides a supporting target device type list to the software management device for each software product. The providing device is equivalent to the information management server in the exemplary embodiment, but the product providing server in the exemplary embodiment may function as a providing device. In the software management device, it is determined whether or not the image forming device is a supporting target, based on the supporting target device type list provided from the providing device. It is possible to integrally manage the substance of an installer and the supporting target device type list by including the supporting target device type list in an installer file.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A software management device comprising:
a determination section that determines whether or not a device is a supporting target in managing a software product installed in the device;
a display that displays an item indicating the software product in both a case where it is determined that the device is a supporting target and a case where it is determined that the device is not a supporting target; and
an operation controller that receives a plurality of types of user operations with respect to a supporting-related product which is a software product installed in the device in a case where it is determined that the device is a supporting target, and restricts reception of all or some of the plurality of types of user operations with respect to an out-of-supporting-related product which is a software product installed in the device in a case where it is determined that the device is not a supporting target.

2. The software management device according to claim 1, further comprising:
a memory that stores an installer corresponding to the software product installed in the device,
wherein the determination section determines that the device is not the supporting target in a case where the installer does not set the device as a supporting target.

3. The software management device according to claim 2,
wherein the installer stored in the memory performs installation, updating, and uninstallation of a software product corresponding to the installer, and
wherein the out-of-supporting-related product installed in the device is a software product installed in the device by an installer which is separate from the installer stored in the memory, and the installer stored in the memory does not perform the updating and the uninstallation.

4. The software management device according to claim 2,
wherein the memory further stores a supporting target device type list which is a list associated with the installer for specifying one or a plurality of devices which are set as supporting targets by the installer, and
wherein the determination section determines whether or not the device is a supporting target, based on the supporting target device type list.

5. The software management device according to claim 4,
wherein the memory stores an installer file for each software product, and
wherein each of the installer files includes the software product, the installer, and the supporting target device type list.

6. The software management device according to claim 1, further comprising:
a generation section that generates a product list which includes the item indicating the software product and is displayed on the display,
wherein the generation section applies a first display condition with respect to the supporting-related product and applies a second display condition different from the first display condition with respect to the out-of-supporting-related product, in generating the product list.

7. The software management device according to claim 6,
wherein the first display condition is a condition for generating the product list so that an updating recommendation mark is displayed, in a case where an updated version for the supporting-related product is published, and
wherein the second display condition is a condition for generating the product list so that the updating recommendation mark is not displayed with respect to the out-of-supporting-related product.

8. The software management device according to claim 6,
wherein the first display condition is a condition for generating the product list so that an item indicating the supporting-related product is displayed in a first display mode, and
wherein the second display condition is a condition for generating the product list so that an item indicating the out-of-supporting-related product is displayed in a second display mode different from the first display mode.

9. The software management device according to claim 6,
wherein the second display condition is a condition for generating the product list so that recommendation information is displayed in association with an item indicating the out-of-supporting-related product, and
wherein the recommendation information is information for prompting a user to take measures for generating a supporting relation.

10. A software management system comprising:
a software management device for managing a software product installed in an image forming device; and
a providing device which is connected to the software management device and provides a supporting target device type list to the software management device for each software product,
wherein the software management device includes
a determination section that determines whether or not the image forming device is supporting target, based on a supporting target device type list corresponding to the software product installed in the image forming device,
a display that displays an item indicating the software product in both a case where it is determined that the image forming device is a supporting target and a case where it is determined that the image forming device is not a supporting target, and
an operation controller that receives a plurality of types of user operations with respect to a supporting-related product which is a software product installed in the device in a case where it is determined that the image forming device is a supporting target, and restricts reception of all or some of the plurality of types of user operations with respect to an out-of-supporting-related product which is a software product installed in the device in a case where it is determined that the image forming device is not a supporting target.

11. A non-transitory computer readable medium storing a program which is executed in an information processing device and is used to manage a software product installed in a device, the program comprising:
a function of determining whether or not the device is a supporting target in managing the software product installed in the device;
a function of causing an item indicating the software product to be displayed on a display unit in both a case where it is determined that the device is a supporting target and a case where it is determined that the device is not a supporting target; and
a function of receiving a plurality of types of user operations with respect to a supporting-related product which is a software product installed in the device in a case where it is determined that the device is a supporting target, and restricting reception of all or some of the plurality of types of user operations with respect to an out-of-supporting-related product which is a software product installed in the device in a case where it is determined that the device is not a supporting target.
